(19) United States
(12) Patent Application Publication
(10) Pub. No.: US 2008/0141879 A1
(43) Pub. Date: Jun. 19, 2008

(54) Gear driven variable cutoff printing press

(75) Inventors: Thaddeus A. Niemiro, Lisle, IL (US); Dan Machaj, Romeoville, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: GOSS INTERNATIONAL CORPORATION, Bolingbrook, IL (US)

(21) Appl. No.: 11/641,256

(22) Filed: Dec. 18, 2006

(51) Int. Cl. B41F 7/02

(52) U.S. Cl. 101/217; 101/492

(57) ABSTRACT

A printing press includes gear driven rollers, such as, for example, a plate cylinder and a blanket cylinder, and a pivotable gear train adapted to synchronize rotation of the cylinders, and is able to accommodate a range of cylinder sizes. Changing cylinder sizes may be accomplished without the need for changing any gears in the gear train.

### FIELD OF THE INVENTION

The present invention is directed to improvements in printing presses and, more particularly, to a printing press that is capable of providing a variable printed image cutoff.

### BACKGROUND OF THE INVENTION

Typically, a printing press will utilize two printing couples and will have an inking mechanism for each of the two printing couples. The printing couples comprise a pair of plate cylinders that are commonly journaled at their opposite ends in spaced parallel side frames as well as a corresponding pair of blanket cylinders that are similarly journaled in the side frames. Further, the printing press often will include a throw-off mechanism usually based on a system of eccentric sleeves and associated linkages.

For a printing press of this type, the press will commonly be designed to utilize a specific diameter of plate and blanket cylinders. It will be understood that the diameter of the cylinders dictates the printed image cutoff, which is difficult to vary since it involves entirely changing the printing press components by essentially rebuilding the press. Understandably, this is a very costly operation to perform, and it is undesirable from the standpoint of productivity and use of resources.

In other words, there is a great amount of “down time” when it is desired to change the cutoff in a conventional printing press. To achieve this objective, it is also necessary to have multiple different sized components including various diameters of plate and blanket cylinders along with different gears, bearings and the like in order to be able to rebuild the press to achieve a different printed image cutoff. As a result, the cost of changing the cutoff has been a deterrent to achieving the level of flexibility that is desired in a printing press.

A quick changeover variable cutoff printing press typically requires independent motors on every cylinder to facilitate printing without the need for gears. Such motors add cost to the printing press and additional complexity. Some printing presses effect cutoff change by changing printing cylinder sizes while driving each cylinder individually by variable speed devices (mostly electric motors) as well as separately driven inkers and dampeners.

Thus, to facilitate a change in cutoff, conventional variable cutoff printing presses typically require cylinder size change, cylinder gear change, and an inker and dampener drive gear change. The inker and dampener drive gear may remain unchanged if driven by a separate set of variable speed devices, to match the cylinder surface speed of the dampener to the cylinder.

### SUMMARY

According to one aspect of the invention, a printing press includes gear driven rollers, such as, for example, a plate cylinder and a blanket cylinder, and a pivotable gear train adapted to synchronize rotation of the cylinders, and is able to accommodate a range of cylinder sizes. A blanket cylinder gear may be fixedly mounted to the blanket cylinder. A plate cylinder gear may be fixedly mounted to the plate cylinder and the pivotable gear train may include two or more gears and/or two or more pivotal links. One pivotal link may be disposed between the center of rotation of the plate cylinder and at least one gear of the pivotable gear train. The pivotable gear train may include a first gear meshing with the plate cylinder gear and a second gear meshing with the first gear and the blanket cylinder gear. The variable cutoff printing press may further including a pivotal link between the first gear and the second gear.

According to another aspect of the invention, the gear train may be rotatable between a first position, corresponding to a maximum cylinder diameter, and a second position, corresponding to a minimum cylinder diameter.

According to yet another aspect of the invention, a variable cutoff printing press includes: a drive mechanism; a plate cylinder rotated by the drive mechanism; a plate cylinder gear fixedly mounted to the plate cylinder; a blanket cylinder; a blanket cylinder gear fixedly mounted to the blanket cylinder; and a pivotable gear train adapted to synchronize rotation of the blanket cylinder with rotation of the plate cylinder.

According to still another aspect of the invention, a method of changing cutoff on a variable cutoff printing press is provided. The printing press may initially include at least one initial blanket cylinder and at least one initial plate cylinder each having a first diameter, and the method may include providing a gear train for synchronizing rotation of the at least one initial blanket cylinder with rotation of the at least one initial plate cylinder and replacing the at least one initial plate cylinder and the at least one initial blanket cylinder with a subsequent plate cylinder and a subsequent blanket cylinder, each having a second diameter different than the first diameter, without changing any component in the gear train.

The invention provides infinitely variable cutoff capabilities within a desired range between a minimum and a maximum cutoff as well as quick changeover capabilities.

### BRIEF DESCRIPTION OF THE DRAWINGS

FIG. 1 is a schematic elevational view of a printing press incorporating the invention in a first configuration, in which the printing press includes plate cylinders and blanket cylinders having a first diameter;

FIG. 2 is a schematic elevational view of the printing press of FIG. 1, in a second configuration, in which he printing press includes plate cylinders and blanket cylinders having a second diameter that is larger than the first diameter; and

FIG. 3 is a diagrammatic perspective view of a portion of the gear train of the printing press of FIG. 1.

### DETAILED DESCRIPTION

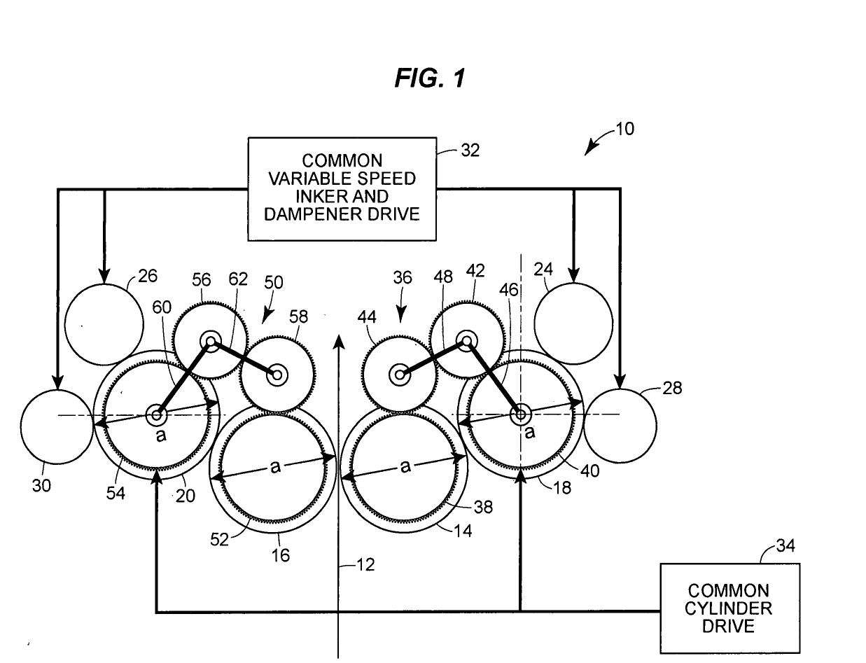

With reference initially to FIG. 1, a printing press, generally indicated at 10, is adapted to print information and/or images onto a web 12 that passes between initial blanket cylinders 14 and 16 (e.g., for back-to-back printing). Each of the initial blanket cylinders 14 and 16 has a first diameter “a” and is in rolling contact with an initial plate cylinder, 18 and 20, respectively, and each of the initial plate cylinders 18 and 20 also has a diameter “a” and is in rolling contact with a respective inker 24 and 26, and dampener 28 and 30. The inkers 24 and 26 and the dampeners 28 and 30 may be driven by a common variable speed inker and dampener drive 32. The initial plate cylinders 18 and 20 may be driven by a common cylinder drive 34.

As shown in the right-hand portion of FIG. 1, in order to synchronize the rotation of the initial blanket cylinder 14 with the rotation of the initial plate cylinder 18, a first transfer gear train, generally indicated at 36, rotationally links the initial blanket cylinder 14 with the initial plate cylinder 18, by meshing with a blanket cylinder gear 38 that may be fixedly attached to the initial blanket cylinder 14 and with a plate cylinder gear 40 that may be fixedly attached to the initial plate cylinder 18. The first transfer gear train 36 may include a first upper transfer gear 42 and a first lower transfer gear 44. The first upper transfer gear 42 may be attached to the center of rotation of the initial plate cylinder 18 via a first plate-to-gear pivoting link 46. The first lower transfer gear 44 may be attached to the first upper transfer gear 42 via a first gear-to-gear pivoting link 48.

In an essentially identical fashion, as shown in the left-hand portion of FIG. 1, in order to synchronize the rotation of the initial blanket cylinder 16 with the rotation of the initial plate cylinder 20, a second transfer gear train, generally indicated at 50, rotationally links the initial blanket cylinder 16 with the initial plate cylinder 20, by meshing with a blanket cylinder gear 52 that may be fixedly attached to the initial blanket cylinder 16 and with a plate cylinder gear 54 that may be fixedly attached to the initial plate cylinder 20. The second transfer gear train 50 may include a second upper transfer gear 56 and a second lower transfer gear 58. The second upper transfer gear 56 may be attached to the center of rotation of the initial plate cylinder 20 via a second plate-to-gear pivoting link 60. The second lower transfer gear 58 may be attached to the second upper transfer gear 56 via a second gear-to-gear pivoting link 62.

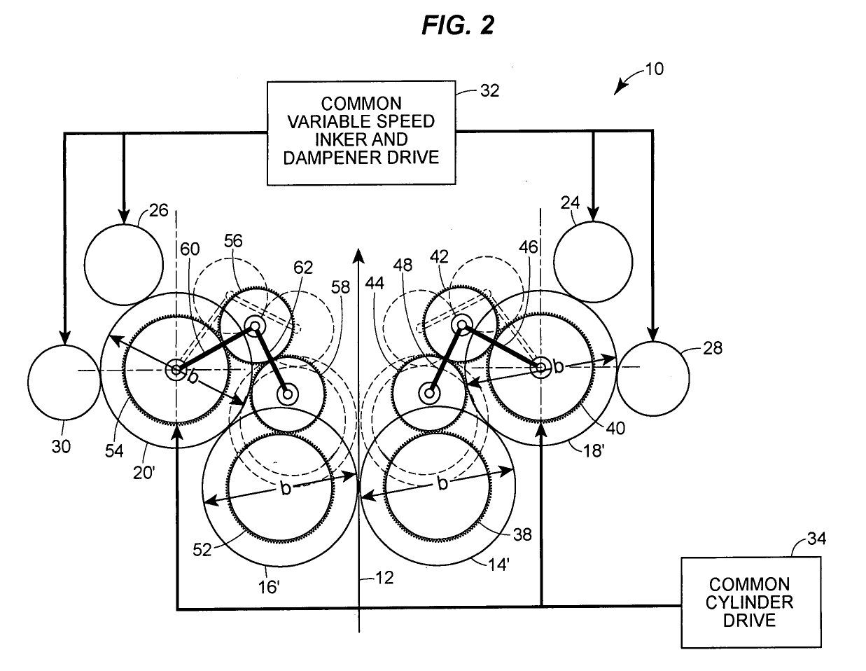

As shown in FIG. 2, the printing press 10 may be configured to use larger size subsequent blanket cylinders 14′ and 16′ and larger size subsequent plate cylinders 18′ and 20′, each of which have a second diameter “b” that is larger than the first diameter “a” of the corresponding cylinders in FIG. 1. (For example, such size changes may be implemented by providing cylinder sleeves with additional thickness.) For ease of comparison, the configuration of the printing press 10 of FIG. 1 is shown in phantom (dashed lines) in FIG. 2. The larger cylinder sizes may be accommodated without the need to change all of the gears 38, 40, 42, 44, 52, 54, 56, or 58, that may be instead repositioned, via the pivoting links 46, 48, 60, and 62.

If desired, the lower transfer gears 44 and 58 may each be provided in a fixed location in relation to the respective blanket cylinder gear 38 and 52, and may be on the same carriage used for cutoff change when the blanket cylinder is changed. The upper transfer gears 42 and 56 may each be rolled around the respective plate cylinder gear 40 and 54 to accommodate a change in the size of the blanket cylinders 14 and 16 and the plate cylinders 18 and 20.

Within a selected cylinder size range, from a minimum diameter of “a” for the initial plate cylinders 18 and 20, and the initial blanket cylinders 14 and 16, as shown in FIG. 1, to a maximum diameter of “b” for the subsequent plate cylinders 18′ and 20′, and the subsequent blanket cylinders 14′ and 16′, as shown in FIG. 2, the cutoff can be infinitely. variable while the gear diameters may all remain unchanged for all of the gears 38, 42, 44, 52, 56, and 58.

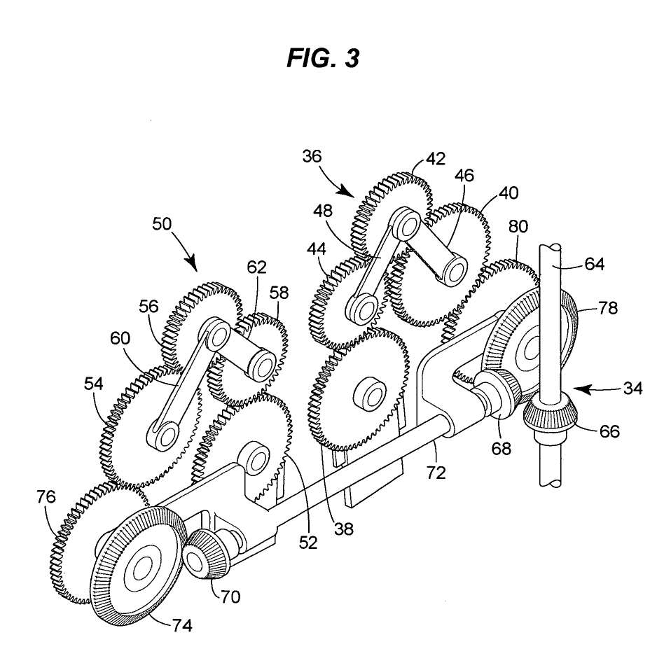

As shown in FIG. 3, the common cylinder drive 34 may include a vertical drive shaft 64 that rotates a first spiral bevel gear 66. The first spiral bevel gear 66 may engage a second spiral bevel gear 78 which is fixedly coaxial with a first plate cylinder drive gear 80. A third spiral bevel gear 68 may be mounted to an end of a horizontal drive shaft 72. A fourth spiral bevel gear 70 may drive a fifth spiral bevel gear 74 which is fixedly coaxial with a second plate cylinder drive gear 76. The third spiral bevel gear 68 may be driven by the second spiral bevel gear 78 that rotates the first plate cylinder drive gear 80. Miter gears may be used instead of spiral bevel gears.

The printing press 10 has been shown and described with the common cylinder drive 34 linked to each of the plate cylinders 18, 20, 18′, and 20′. However, the printing press 10 may be driven either mechanically or electrically through any one of the gears 38, 42, 44, 52, 54, 56, 58, 76, or 80, that each may be tied in a synchronized fashion for the same pitch velocity.

The inker and dampener drive 32 may be driven by a separate variable speed arrangement adjusted to match the printing cylinder surface velocity. The inker and dampener drive 32 may be an electrical motor, but other types of drives are of course possible.

It should be noted that, although depicted in connection with a printing press that performs offset printing, the invention may be used in other types of variable cutoff printing presses, such as, for example printing presses that use flexography, gravure, etc.

From the foregoing, it will also be appreciated that the actual mounting hardware, as well as the actual drive or drives for the printing press 10 have not been shown. This is because the press drive or drives and other associated components such as mounting hardware, adjustment gears and the like may take any conventional form and are not necessary for understanding the present invention. Thus, the present invention is not dependent on mounting hardware or the drive or drives which can readily be selected and implemented by those of ordinary skill in the art.

While in the foregoing there has been set forth a preferred embodiment of the invention, it will be appreciated that the details herein given may be varied by those skilled in the art without departing from the true spirit and scope of the appended claims.

What is claimed is:

1. A variable cutoff printing press comprising:
a drive mechanism;
a plate cylinder rotated by the drive mechanism;
a plate cylinder gear attached to the plate cylinder;
a blanket cylinder;
a blanket cylinder gear attached to the blanket cylinder; and
a pivotable gear train adapted to synchronize rotation of the blanket cylinder with rotation of the plate cylinder.

2. The variable cutoff printing press of claim 1, wherein the blanket cylinder gear is fixedly mounted to the blanket cylinder.

3. The variable cutoff printing press of claim 1, wherein the plate cylinder gear is fixedly mounted to the plate cylinder.

4. The variable cutoff printing press of claim 1, wherein the pivotable gear train comprises two or more gears.

5. The variable cutoff printing press or claim 1, wherein the pivotable gear train comprises two or more pivotal links.

6. The variable cutoff printing press of claim 1, wherein a pivotal link is disposed between the center of rotation of the plate cylinder and at least one gear of the pivotable gear train.

7. The variable cutoff printing press of claim 1, wherein the pivotable gear train includes a first gear meshing with the plate cylinder gear and a second gear meshing with the first gear and the blanket cylinder gear.

8. The variable cutoff printing press of claim 7, further including a pivotal link between the first gear and the second gear.

9. The variable cutoff printing press of claim 1, wherein the gear train is rotatable between a first position, corresponding to a maximum cylinder diameter, and a second position, corresponding to a minimum cylinder diameter.

10. A variable cutoff printing press comprising:
a drive mechanism;
a plate cylinder rotated by the drive mechanism;
a plate cylinder gear fixedly mounted to the plate cylinder;
a blanket cylinder;
a blanket cylinder gear fixedly mounted to the blanket cylinder; and
a pivotable gear train adapted to synchronize rotation of the blanket cylinder with rotation of the plate cylinder.

11. The variable cutoff printing press of claim 10, wherein the pivotable gear train comprises two or more gears.

12. The variable cutoff printing press or claim 10, wherein the pivotable gear train comprises two or more pivotal links.

13. The variable cutoff printing press of claim 10, wherein a pivotal link is disposed between the center of rotation of the plate cylinder and at least one gear of the pivotable gear train.

14. The variable cutoff printing press of claim 10, wherein the pivotable gear train includes a first gear meshing with the plate cylinder gear and a second gear meshing with the first gear and the blanket cylinder gear.

15. The variable cutoff printing press of claim 14, further including a pivotal link between the first gear and the second gear.

16. The variable cutoff printing press of claim 10, wherein the gear train is rotatable between a first position, corresponding to a maximum cylinder diameter, and a second position, corresponding to a minimum cylinder diameter.

17. A method of changing cutoff on a variable cutoff printing press, the printing press initially including at least one initial blanket cylinder and at least one initial plate cylinder each having a first diameter, the method comprising:
providing a gear train for synchronizing rotation of the at least one blanket cylinder with rotation of the at least one plate cylinder; and
replacing the at least one plate cylinder and the at least one blanket cylinder with a subsequent plate cylinder and a subsequent blanket cylinder, respectively, each of the subsequent plate cylinder and the subsequent blanket cylinder having a second diameter different than the first diameter, without changing any component in the gear train.

18. The method of claim 17, wherein a plate cylinder gear is attached to the plate cylinder, and wherein replacing the cylinders includes rolling at least one gear of the gear train around the plate cylinder gear.

19. The method of claim 17, wherein a plate cylinder gear is attached to the plate cylinder, and replacing the cylinders is performed without changing the plate cylinder gear.

20. The method of claim 17, wherein a blanket cylinder gear is attached to the blanket cylinder, and replacing the cylinders is performed without changing the blanket cylinder gear.
